(19) United States
(12) Patent Application Publication
(10) Pub. No.: US 2021/0055263 A1
(43) Pub. Date: Feb. 25, 2021

(54) METHOD FOR MEASURING FORMATION CONDUCTIVITY DISTRIBUTION BASED ON TRANSIENT ELECTROMAGNETIC EDDY CURRENT FIELD

(71) Applicant: Beijing Huahui Shengshi Energy Technology Co., Ltd, Beijing (CN)

(72) Inventor: Yongjin SHEN, Beijing (CN)

(73) Assignee: Beijing Huahui Shengshi Energy Technology Co., Ltd, Beijing (CN)

(21) Appl. No.: 16/664,131

(22) Filed: Oct. 25, 2019

(30) Foreign Application Priority Data
Aug. 22, 2019 (CN) 201910778307. 7

(51) Int. Cl. G01N 27/90

(52) U.S. Cl. CPC G01N 27/9013; G01N 27/9066

(57) ABSTRACT

A method for measuring formation conductivity distribution based on transient electromagnetic eddy current field is provided. The method includes arranging a transmitter coil and a first array receiver coil to a target stratum of a transmitter well, arranging a second array receiver coil to a target stratum of a receiver well, periodically turning on and off the transmitter coil, moving the transmitter coil and the first array receiver coil for a first preset distance, acquiring a first eddy current signal of the first array receiver coil and a second eddy current signal of the second array receiver coil in a moving process of the first preset distance, moving the second array receiver coil for a second preset distance, moving the transmitter coil and the first array receiver coil for the first preset distance till the measurement of the whole well segments is completed, and obtaining formation conductivity distribution.

### CROSS-REFERENCE TO RELATED APPLICATION

This application claims priority to Chinese Patent Application No. 201910778307. 7 filed on Aug. 22, 2019, the entire contents of which are herein incorporated by reference.

### TECHNICAL FIELD

The present invention relates to the technical field of conductivity distribution, and in particular to a method for measuring formation conductivity distribution based on transient electromagnetic eddy current field.

### BACKGROUND

The existing transient electromagnetic exploration technology generally uses large coils to excite a transient electromagnetic field on the ground and receives signals on the ground, where a distance between a transmitter coil and a receiver coil is 0, and to a conductive medium, there is a response of a half space (where the other half space is air and is non-conducting), so an amplitude of receiving signals is great, and an amplitude of signals directly coupled by the transmitter coil in the receiver coil is great, that is, the amplitude of useless signals is great, the amplitude of useful signals associated with formation conductivity is small, the multiplicity of formation conductivity distribution is identified by only utilizing information in response caused on the ground when the transient electromagnetic field propagates in the formation, but not directly utilizing propagation characteristics of the transient electromagnetic field in the formation, and it is caused that many different formation conductivity distributions obtain the same shape of response waveforms and the spatial resolution of the formation conductivity is low.

### SUMMARY

An objective of the present invention is to provide a method for measuring formation conductivity distribution based on transient electromagnetic eddy current field, which can improve spatial resolution and accuracy of measured formation conductivity.

To achieve the above purpose, the present invention provides the following technical solution.

A method for measuring formation conductivity distribution based on transient electromagnetic eddy current field includes: arranging a transmitter coil and a first array receiver coil to a target stratum of a transmitter well; arranging a second array receiver coil to a target stratum of a receiver well; periodically turning on and turning off the transmitter coil; moving the transmitter coil and the first array receiver coil for a first preset distance; acquiring a first eddy current signal of the first array receiver coil and a second eddy current signal of the second array receiver coil in a moving process of the first preset distance; moving the second array receiver coil for a second preset distance; jumping to the step of moving the transmitter coil and the first array receiver coil for the first preset distance till the measurement of the whole well segments is completed; and obtaining formation conductivity distribution according to the first eddy current signal and the second eddy current signal.

Optionally, the transmitter coil and the first array receiver coil are connected by a connecting rod.

Optionally, there are one or more receiver wells.

Optionally, the periodically turning on and turning off the transmitter coil includes forward turning on, forward turning off, reverse turning on and reverse turning off.

Optionally, the periodically turning on and turning off the transmitter coil includes delaying 60 ms, forwardly turning on 60 ms, forwardly turning off 60 ms, reversely turning on 60 ms and reversely turning off 160 ms.

Optionally, the first preset distance is greater than the second preset distance.

Optionally, the obtaining formation conductivity distribution according to the first eddy current signal and the second eddy current signal includes: obtaining a formulation conductivity curve by using deconvolution according to the first eddy current signal; obtaining spatial formation conductivity distribution by using a whole-space geometric factor according to the second eddy current signal; and conducting constraint solving on the spatial formation conductivity distribution by taking the formation conductivity curve as a known boundary condition to obtain the formation conductivity distribution.

According to specific embodiments provided in the present invention, the present invention discloses the following technical effects.

The present invention can generate a low-frequency electromagnetic field with continuous spectrum by periodically turning on and turning off the transmitter coil, and the low-frequency electromagnetic field has a great skin depth, can effectively penetrate a transmitter well into the formation and overcomes the shielding function of the transmitter well; the transmitter well is internally provided with a transmitter coil and also provided with a first array receiver coil such that the transmitter well can provide a transient electromagnetic field for a receiver well and can also receive the transient electromagnetic field to conduct continuous measurement on formation conductivity outside the transmitter well so as to obtain a formation conductivity curve; and the transmitter coil and the first array receiver coil simultaneously and continuously move and measure to obtain continuous transient electromagnetic full wave forms in the transmitter well and between the transmitter well and the receiver well so as to more comprehensively and accurately reflect the formation conductivity distribution, and the array receiver coil adopts a non-contact measurement method, which is easier to be operated, highly efficient and safe to constructors.

### BRIEF DESCRIPTION OF THE DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a method for measuring formation conductivity distribution based on transient electromagnetic eddy current field of the present invention;

FIG. 2 is a diagram showing a connection relationship between a transmitter coil and a first array receiver coil of the present invention;

FIG. 3 is a shape diagram of a transient electromagnetic excitation waveform of the present invention;

FIG. 4 is a diagram of transient electromagnetic response waveforms in a transmitter well of the present invention;

FIG. 5A is a diagram showing a transient electromagnetic excitation response propagating process of the present invention;

FIG. 5B is a diagram showing a transient electromagnetic excitation response propagating process of the present invention;

FIG. 5C is a diagram showing a transient electromagnetic excitation response propagating process of the present invention;

FIG. 5D is a diagram showing a transient electromagnetic excitation response propagating process of the present invention;

FIG. 6 is a shape diagram of response waveforms generated by a transient electromagnetic eddy current of the present invention;

FIG. 7 is a schematic diagram showing contribution of whole-space each point formation conductivity to eddy-current-excited response when a transmitter coil and a receiver coil are not on the same axis according to the present invention;

FIG. 8 is a schematic diagram of a conductive thin plate and an excitation coil according to an embodiment of the present invention;

FIG. 9A is a schematic diagram showing that a Doll geometric factor turns to a radius direction during receiving at different source distances according to the present invention;

FIG. 9B is a schematic diagram showing that a Doll geometric factor turns to a radius direction during receiving at different source distances according to the present invention;

FIG. 10A is a schematic diagram showing spatial distribution of a Doll geometric factor of the present invention;

FIG. 10B is a schematic diagram showing spatial distribution of a Doll geometric factor of the present invention;

FIG. 10C is a schematic diagram showing spatial distribution of a Doll geometric factor of the present invention;

FIG. 11A is a schematic diagram showing subtraction results of cased hole response waveforms and different formation conductivity response waveforms according to the present invention;

FIG. 11B is a schematic diagram showing results when amplitudes of response waveforms at different source distances are represented by gray scales;

FIG. 11C is a schematic diagram showing changes of the amplitude along with the source distance after response waveforms obtained by different medium conductivities are subtracted;

FIG. 12A is a schematic structural diagram of transmitter and receiver coils of the present invention;

FIG. 12B is a diagram of an original logging waveform of a cased hole of 5.5 inches; and

FIG. 13 is a waveform diagram after two waveforms measured at different depth and the same source distance are subtracted according to the present invention.

### DETAILED DESCRIPTION OF EMBODIMENTS

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

An objective of the present invention is to provide a method for measuring formation conductivity distribution based on transient electromagnetic eddy current field, which can improve spatial resolution and accuracy of measured formation conductivity.

To make the foregoing objective, features, and advantages of the present invention clearer and more comprehensible, the present invention is further described in detail below with reference to the accompanying drawings and specific embodiments.

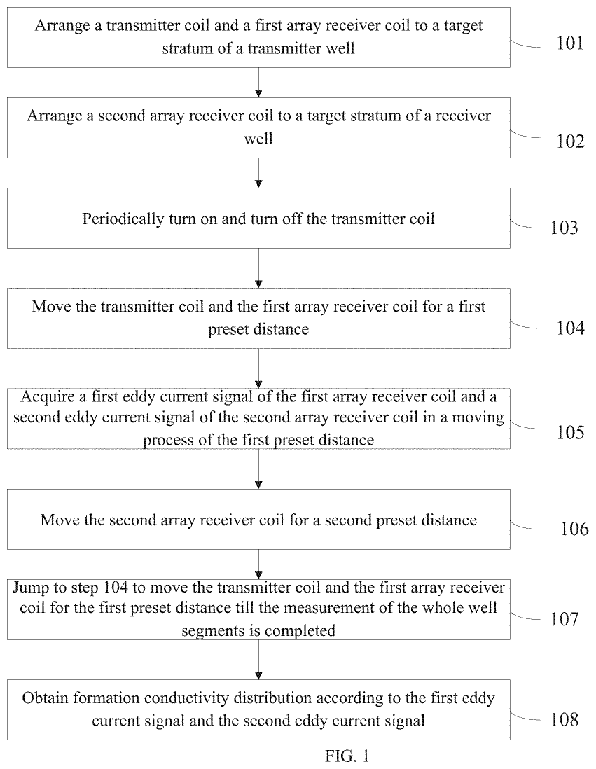

FIG. 1 is a flowchart of a method for measuring formation conductivity distribution based on transient electromagnetic eddy current field of the present invention. As shown in FIG. 1, the method for measuring formation conductivity distribution based on transient electromagnetic eddy current field includes:

Step 101: arrange a transmitter coil and a first array receiver coil to a target stratum of a transmitter well;

Step 102: arrange a second array receiver coil to a target stratum of a receiver well;

Step 103: periodically turn on and turn off the transmitter coil;

Step 104: move the transmitter coil and the first array receiver coil for a first preset distance;

Step 105: acquire a first eddy current signal of the first array receiver coil and a second eddy current signal of the second array receiver coil in a moving process of the first preset distance;

Step 106: move the second array receiver coil for a second preset distance;

Step 107: jump to step 104 to move the transmitter coil and the first array receiver coil for the first preset distance till the measurement of the whole well segments is completed; and

Step 108: obtain formation conductivity distribution according to the first eddy current signal and the second eddy current signal.

Where the transmitter coil in step 101 uses a transverse H-shaped framework, the middle portion of the framework is a hollow column, in which a magnetic material is filled, the exterior of the column is wound with an enameled wire with the diameter of 1 mm, and the number of the winding turns is increased with the increasing of the length of the coil; the receiver coil has the same structure as the transmitter coil except that the diameter of an enameled wire wound around the exterior of a column of the receiver coil is slightly smaller, the number of turns of the receiver coil in the transmitter well is 8,000 while the number of turns of the receiver coil in the receiver well is up to 30,000-80,000, and a plurality of receiver coils are equidistantly arranged together to form an array receiver coil; the transmitter coil is connected with the first array receiver coil through a hard connecting rod, as shown in FIG. 2; and the target stratum in step 101 represents a preset depth.

There is one or more receiver wells in step 102; and when there are multiple receiver wells, their measurement manners are the same as the measurement manner of one receiver well, and at this time, the second array receiver coils in the multiple receiver wells need to move simultaneously.

In step 103, the transmitter coil is periodically turned on and turned off, that is, the transmitter coil adopts a bipolar excitation manner: forward turning on, forward turning off, reverse turning on and reverse turning off, and specifically, it can be configured as: delaying 60 ms, forwardly turning on 60 ms, forwardly turning off 60 ms, reversely turning on 60 ms and reversely turning off 160 ms.

The first preset distance is greater than the second preset distance from step 104 to step 106 such that there is an overlap during each measurement.

In step 105, a first eddy current signal of the first array receiver coil and a second eddy current signal of the second array receiver coil in a moving process of the first preset distance are acquired, that is, a high-precision (24-bit AD) acquisition system connected with each receiver coil is used for conducting AD conversion on each waveform, converting analog signals excited by twice turning on and twice turning off into digital signals, and completely transmitting the digital signals to a computer, and subsequently, the formation conductivity distribution is obtained by using a whole-space geometric factor modeling processing method. Step 108 of moving the second array receiver coil for a second preset distance includes:

obtain a formulation conductivity curve by using deconvolution according to the first eddy current signal; obtain spatial formation conductivity distribution by using the whole-space geometric factor according to the second eddy current signal; and conduct constraint solving on the spatial formation conductivity distribution by taking the formation conductivity curve as a known boundary condition to obtain the formation conductivity distribution.

Specifically, to waveforms measured in the transmitter well, according to one-way propagation characteristics of an eddy current field, a waveform measured at a later depth is subtracted from a waveform measured at a former depth to obtain a response waveform excited by a formation eddy current, (great useless signals in the waveforms are the same at two measurement points so as to be capable of being subtracted, and then the residual is a difference of the measured formation conductivities), response values of multiple times are acquired to be combined to form a formation conductivity original logging curve (a difference of conductivity responses measured at two adjacent points), and then a formation conductivity curve is obtained by using the deconvolution. To response waveforms received by the receiver well, the useless signals are removed by utilizing a method for subtracting waveforms measured at adjacent positions, the whole-space geometric factor is used for modeling after only an eddy-current-excited response is left, the whole-space geometric factor provides an expression of a response excited by each point eddy current and received by an adjacent well, the expression describes the contribution of conductivity of any space point to the response, and the expression is used to conduct the deconvolution to obtain the spatial formation conductivity distribution. Finally, a difference between an eddy-current-excited response calculated by using the whole-space geometric factor and a practically measured eddy-current-excited response is squared and then added to establish an objective function, and a distribution making the objective function be minimum is the final conductivity distribution. In processes of conducting spatial conductivity distribution deconvolution and optimizing the objective function, formation conductivity measured by the transmitter well, in which the transmitter coil is located, can be taken as the known boundary condition to conduct the constraint solving so as to obtain the formation conductivity distribution.

The specific working process and principle of the present invention are:

the transmitter coil and the first array receiver coil as well as the second array receiver coil of an adjacent well are arranged to the bottom of a well or near a target stratum; under the control of a ground system, the transmitter coil periodically and continuously turns on and turns off a coil current according to an excitation logic (delaying 60 ms, forwardly turning on 60 ms, turning off 60 ms, reversely turning on 60 ms and turning off 160 ms), all receiver coils in the first array receiver coil and the second array receiver coil receive transient electromagnetic response signals, and simultaneously, the high-precision (24-bit AD) acquisition system connected with each receiver coil is started to conduct the AD conversion on each waveform and to completely convert and transmit the responses excited by the twice turning on and the twice turning off to the computer; the transmitter coil and the first array receiver coil connected with the transmitter coil through the hard connecting rod continuously move, the above acquisition process is repeated to obtain responses of the first array receiver coil and the second array receiver coil in the transmitter well and the receiver well when the transmitter coil continuously moves, and cross-well conductivity distribution is scanned and measured; after one sector measurement is completed, the transmitter coil stops moving, and the acquisition system stops working; and the second array receiver coils in all receiver wells move to a central position of a next sector to start measurement of another sector, and the above measuring process is repeated, that is, the excitation logic of the transmitter coil and all acquisition systems start to acquire response signals received by each receiver coil, and the transmitter coil and its hardly connected first array receiver coil continuously move till the measurement is completed.

The specific moving process is: firstly the second array receiver coil of the receiver well is fixed, the transmitter coil of the transmitter well and its hardly connected first array receiver coil continuously move to be measured, where the movement distance is L, so the measurement of one sector is completed; then the movement and the measurement are stopped, the second array receiver coil in the receiver well moves for a movement distance R, then the second array receiver coil is fixed; the transmitter coil in the transmitter well moves downwards for a distance M, then the measurement is restarted; the transmitter coil continuously moves upwards for a movement distance of L to complete the measurement of a second sector; and the above process is repeatedly conducted till the measurement of the whole well segments is completed.

Another movement measurement manner is: after the measurement of one sector is completed, the transmitter coil is fixed, transient electromagnetic transmission of the transmitter coil is not stopped, and when the second array receiver coil of the receiver well moves for the distance R, the measurement is still conducted. Such measured full waveforms are response waveforms when the transmitter coil is fixed and the receiver coil moves.

Where L is a measurement region, generally is greater and has a certain overlap with a former measurement region during each measurement; in order to ensure that there is an overlapped measurement region during each measurement, the measurement is restarted after the transmitter coil moves downwards for the distance M, the M is a control variable, generally is small and is determined according to the specific overlapped region or repeated measurement region, and the movement distance R of the second array receiver coil should be less than the movement distance L of the first array receiver coil. When multiple receiver wells operate, movement and measurement manners of each receiver well are the same as the receiving manner of a single receiver well, and array receiver coils of multiple receiver wells simultaneously move.

In the above process, the transmitter coil in the transmitter well completes not only transmission of cross-well transient electromagnetic exploration signals, but also measurement of through casing conductivity of the transmitter well, all measurements are continuous, the efficiency is high, and the receiver well receives the transient electromagnetic field exited from the transmitter well.

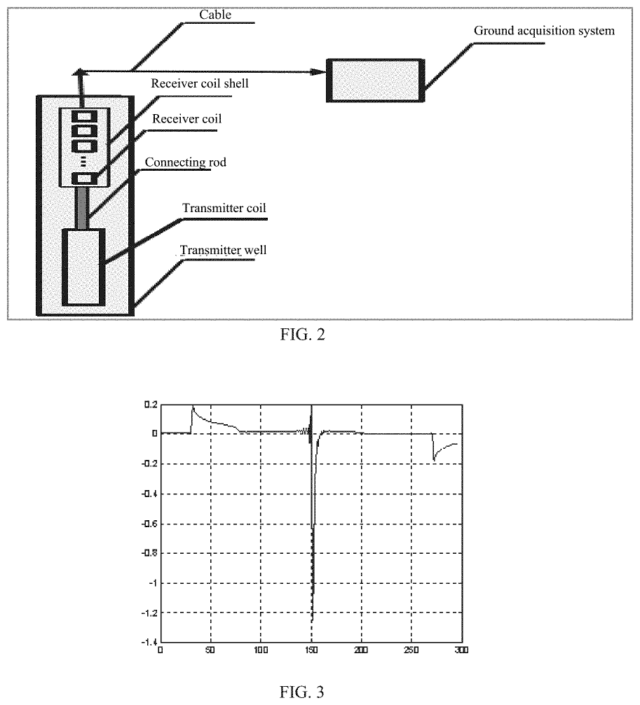

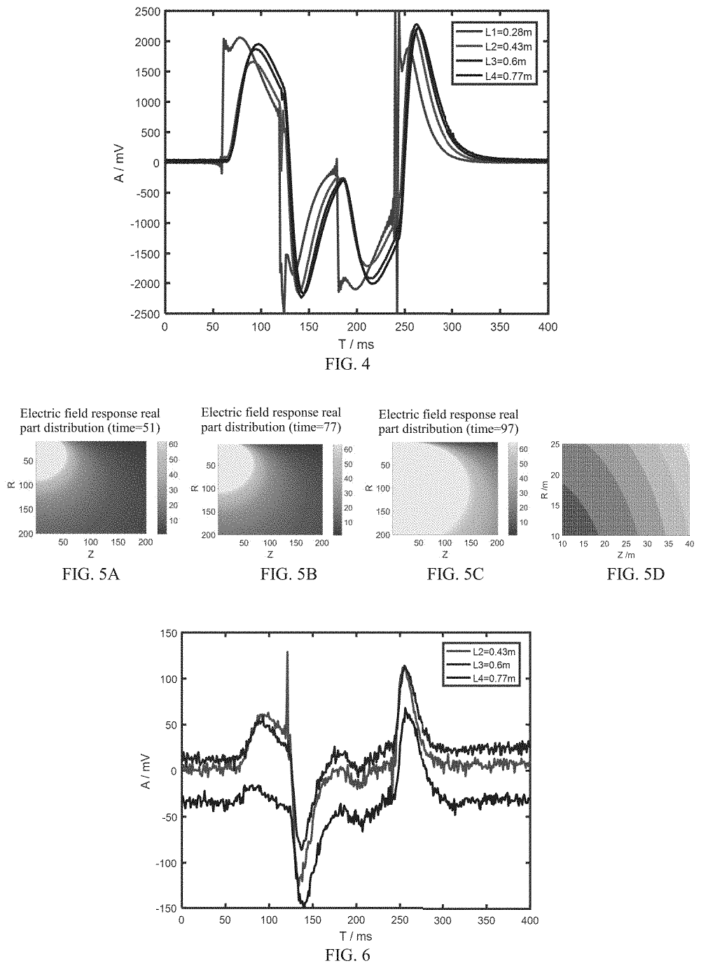

The transmitter coil excites the transient electromagnetic field in the turning on and turning off processes, and the shape of its excited waveform is shown in FIG. 3; and in FIG. 3, a first peak (at 30 ms) is a voltage waveform of two ends of a coil at a forward turning on moment, a downward peak (at 150 ms) is a voltage waveform of the two ends of the coil at a turning off moment, its amplitude is great, and the coil current is turned on and turned off under the voltage, where the turning on time is long, and the turning off time is short and then is quickly reduced to 0. A strong transient electromagnetic field is respectively generated in the formation at the turning on moment and the turning off moment, and the last peak is a voltage waveform of the coil at a reversely turning on moment. The transient electromagnetic field generated at the turning off moment is far greater than the transient electromagnetic field generated at the turning on moment, and the transient electromagnetic excitation is the most efficient. Response waveforms received by the receiver coils in the transmitter well are shown in FIG. 4; with the increasing of the source distance, the peak of a response waveform moves backwards, which represents that the transient electromagnetic field has propagation characteristics in a cased hole, and the shapes of waveforms received at different source distances are different; the waveform received at the closest source distance generates steps at the turning on and turning off moments, the waveforms at the other source distances is to quickly increase, and slowly reduce after reaching the peak, and a peak formation time is prolonged with the increasing of the source distance, in which the propagation process can be remarkably seen. FIG. 5 shows a propagating process of a transient electromagnetic field in the formation, where FIGS. 5A, 5B, and 5C are spatial distribution diagrams of the transient electromagnetic field excited by the coil in radius R and the depth directions at different moments, it can be seen that distribution of the electromagnetic field expands outwards with the increasing of the time, which represents that the transient electromagnetic energy propagates outwards, FIG. 5D shows distribution of the peak at different times and describes a peak propagating process, and in the transient electromagnetic field which propagates outwards, an eddy current field is accompanied. FIG. 6 shows response waveforms regenerated by the eddy current, which is excited by the transient electromagnetic field in the transmitter well in the formation, on the receiver coil, the response waveform is obtained after waveforms received at adjacent depth points in the transmitter well are subtracted (where responses unassociated with the formation conductivity are removed), a first peak corresponds to the forward turning on moment, a second downward peak represents a response generated at the forward turning off moment, and the last upward peak represents a response generated at the reverse turning off moment. Four effective peaks are generated at four effective excitation (forward turning on, forward turning off, reverse turning on and reverse turning off) moments; each point of a waveform forms a conductivity logging curve, the amplitude of four peak positions is the maximum and measurement sensitivity thereof is the highest, and the peak is directly proportional to the formation conductivity; and the four peaks are taken out and laminated together such that spontaneous potential interference can be eliminated and a changing curve of high-sensitivity conductivity with the depth is obtained, and a conductivity curve is obtained after calibration.

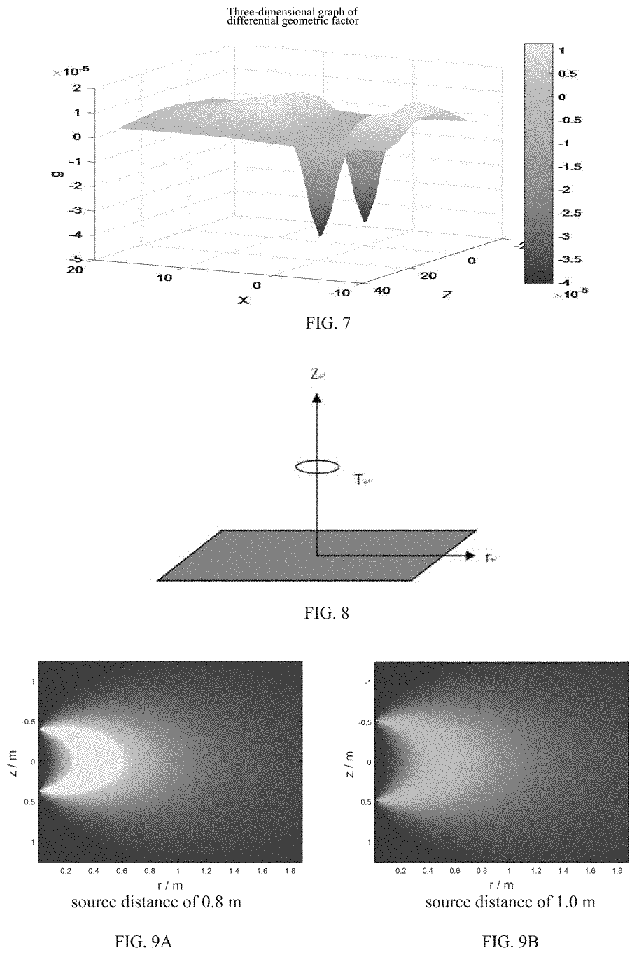

FIG. 7 shows contribution (such as a geometric factor and a weighted value) of whole-space each point formation conductivity to an eddy-current-excited response when the transmitter coil and the receiver coil (two downward peaks) are not located in the same axis, and a response excited by cross-well formation eddy current is a product of spatial each point conductivity and its corresponding whole-space geometric factor. To a response waveform received by the receiver well, cross-well array receiver transient electromagnetic response waveforms can be processed by using the whole-space geometric factor shown in FIG. 7 so as to obtain spatial distribution of the formation conductivity.

The geometric factor provides a contribution weight of conductivity of spatial all points σ to eddy-current-excited signals V_{R} received by the receiver well:

V_{R}(t,x,y,z)=−K∫_{-∞}^{∞}ω²I(ω)e^{jωt}dω∫_{-∞}^{∞}∫_{-∞}^{∞}∫_{-∞}^{∞}g(\dot{x},\dot{y},ż)σ(\dot{x},\dot{y},ż)d\dot{x}d\dot{y}dż

Where I(ω) is a frequency spectrum of an exciting current, ω=2πf, K is an instrument constant, g is a whole-space geometric factor, t is time, and x, y, z represent a rectangular coordinate system. Therefore, a method for processing waveforms received by the receiver well is established. By modeling, array receiving signals are applied to obtain accurate formation conductivity distribution.

Theoretical derivation and associated experimental verification of one-way propagation characteristics of a coil-excited eddy current in a conductive medium is: an infinitely thin flat plate is taken from an infinite and even conductive medium, and without considering influence between the plates, the coil-excited eddy current propagates in one way along the coil axis and is not reflected, and its speed is a constant. The shapes of waveforms received at different positions of the coil axis are the same, and there is a time delay. The thin flat plate is further decomposed to be a unit loop coaxial with the coil such that a response excited by the eddy current on the unit loop in the coil axis is described by applying a Doll geometric factor, and it describes the contribution of eddy currents of formations with different depths in the radial direction to the response. A complete image of eddy current propagation is: the eddy current propagates in the axial direction, and in the past mediums, a medium on the axis does not have contribution to the response, and an ellipsoidal medium using the transmitter coil and the receiver coil as two ends has a great contribution to the response.

In a conductive medium, a coil-excited induction field generates an eddy current which exists in accompanying with the transient electromagnetic field, but its propagation characteristics are very different from these of the transient electromagnetic field. The transient electromagnetic field bidirectionally propagates in the conductive medium and has a great attenuation, and the propagation speed caused by phase movement changes along with the frequency; however, the eddy current excited by the transient electromagnetic field propagates in one direction and has a small attenuation, and its speed is a constant.

As shown in FIG. 8, a planar thin plate is taken from the infinite and even conductive medium, its thickness is infinitely small, conductivity is σ, magnetic permeability is μ, a transmitter coil T is arranged in parallel at a position above the planar thin plate for a distance h, and the coil axis is superposed with the planar thin plate in a normal direction. A cylindrical coordinate system is selected, the z-coordinate is consistent with the coil axis, and the origin of coordinates is arranged on the conductive thin plate.

When the coil current is changed, the transient electromagnetic field is excited in vacuum and the conductive thin plate, where the transient electromagnetic field has components in r and z directions and is axially symmetric and volute. A vortex electric field in the conductive thin plate can excite a vortex current j(r), which is a function of the radius r. An eddy current I(r)=∫ₑ^{∞} j(ξ)dξ is defined, and based on the ampere circuital theorem: I= [symbol] ·\vec{d}l, a loop starts from an r position to the infinity along an upper interface of the thin plate and returns from the infinity to the r position along a lower interface in the radius direction. Then,

$$j ( r ) = \frac{\partial I}{\partial r} \text{:}$$

$$μ j ( r ) = μ \frac{\partial }{\partial r} ( {∮}_{L} {H}^{->} \cdot d {l}^{->} ) = μ \frac{\partial }{\partial r} {\int }_{r}^{∞} 2 {H}_{r} d ξ = 2 μ {H}_{r} = 2 {B}_{r}$$

Where Bᵣ is a component of electromagnetic induction intensity \vec{B} of an upper surface and a lower surface of a part, having the radius of r, of the conductive thin plate in the radius direction, where

$$j = \frac{2 {B}_{r}}{μ} .$$

In the conductive thin plate, based on the Ohm's law: j=σE_{φ}, where E_{φ} is an electric field intensity in a peripheral direction, so:

$${E}_{ϕ} = \frac{2 {B}_{r}}{σ μ} ,$$

a magnetic vector potential \vec{A} is defined to be: \vec{B}=∇×\vec{A}, and according to the law of electromagnetic induction of Maxwell equation

$$∇ \times {E}^{->} = - \frac{\partial {B}^{->}}{\partial t} , {E}^{->} = - \frac{\partial {A}^{->}}{\partial t}$$

is obtained. The coil current is in the peripheral direction, so its excited potential function also only has a component in the peripheral direction; the electromagnetic induction electromotive force is in the peripheral direction E_{φ}, so the eddy current is also in the peripheral direction, its excited potential function also only has a component in the peripheral direction: \vec{A}=A_{φ}\vec{φ}, which is substituted into a curl formula in the column coordinate system and considers the axial symmetry to obtain:

$${B}_{r} = - \frac{\partial {A}_{ϕ}}{\partial z} , but {E}_{ϕ} = - \frac{\partial {A}_{ϕ}}{\partial t} ,$$

so as to finally obtain an equation met by the potential function of the eddy current in the conductive thin plate:

$$\frac{\partial {A}_{ϕ}}{\partial t} = \frac{2}{σ μ} \frac{\partial {A}_{ϕ}}{\partial z} \qquad ( 1 )$$

It is a one-order wave equation, which describes that a magnetic field re-excited by the electromagnetic induction eddy current in the conductive thin plate propagates in a z negative direction, and its propagation speed is related to conductivity and magnetic permeability of the conductive thin plate and is a constant

$$\frac{2}{μ σ} ,$$

which is not changed along with the frequency.

In the conductive thin plate, the potential function of the eddy-current-excited magnetic field can be represented as:

$${A}_{ϕ} = f ( z + \frac{2}{μ σ} t ) \qquad ( 2 )$$

It is a solution of the one-order wave equation (1), which represents that an eddy-current-excited response propagates in the conductive thin plate in the z negative direction in the form of waves. It is a second-order differential equation met by one-way propagated waves and the electromagnetic field excited by the coils in the conductive medium:

∇²A_{φ}=jωσμA_{φ} (3)

There is a difference: the second-order differential equation (3) has two solutions, propagation is conducted respectively in two directions, the propagation speed is

$$2 \sqrt{\frac{π f}{σμ}}$$

and is changed along with the frequency f, and reflection is generated on the interface.

The above equations are obtained by randomly taking one thin plate from the conductive medium without considering interaction of plates, and approximatively describe propagation characteristics of the eddy-current-excited field in the whole conductive medium. When there are multilayer mediums in the radius direction, it can be similarly deduced that each layer i has the eddy current and the propagation speed

$$\frac{2}{{μ}_{i} {σ}_{i}} ,$$

and eddy-current-excited responses having different propagation speeds and generated by different formations can be received in the axis.

Doll takes one unit loop from the conductive medium to study, equivalently takes one unit loop coaxial with the transmitter coil from the thin plate to independently analyze its eddy current and eddy-current-excited response. Induced electromotive force in the unit loop can be obtained by using magnetic flux of a coil-excited magnetic field through the unit loop and is multiplied by conductivity of the unit loop to obtain the eddy current, and response re-excited by the eddy current in the coil axis is equal to a product of multiplying the conductivity of the unit loop with Doll geometric factor (namely contribution of conductivity of space all points to eddy-current-excited response). It equivalently provides distribution of medium scanned by the eddy current when the eddy current propagates along the coil axis.

Spatial distribution described by the Doll geometric factor and propagation speed of the eddy current in the axial direction are combined together so as to be capable of concluding propagation characteristics of the eddy current and its excited field: the eddy current propagates in the conductive medium at a constant speed in an axial direction of the transmitter coil. From the transmitter coil to the receiver coil, the eddy-current-excited response has the time delay, and the time delay is the same to all frequencies, so, the shapes of the eddy-current-excited response waveforms received at different source distance are consistent. However, when the eddy current propagates in the axial direction, the contribution of formation conductivity at different radius to the eddy-current-excited response is different. FIGS. 9A and 9B show the Doll geometric factor, which is blue over the axis (a left side boundary) and has the amplitude of 0, and the formation does not have contribution to the response. A yellow region on a propagation passing path (z) turns to the radius direction, and the more yellow the region is, the greater the geometric factor of the region is, and the greater the contribution to the eddy-current-excited response is. When a receiving source distance is different, the radius occupied by the yellow region is different. The greater the source distance is, the greater the region turning to the radius direction is.

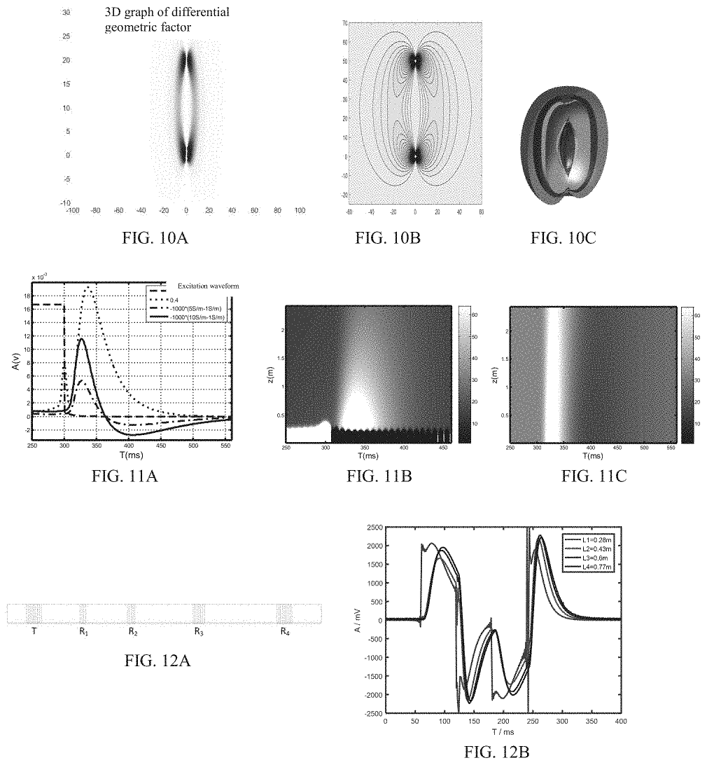

Each of FIGS. 10A and 10B is a Doll geometric factor of a single space point in the conductive medium and is obtained by dividing the Doll geometric factor shown in FIGS. 9A and 9B by the perimeter. The radius around the transmitter and receiver coils approaches 0, so the geometric factor at the point is great (which is a black position in FIGS. 10A and 10B). A yellow region in FIG. 10A turns to the radius direction from the transmitter coil to the receiver coil (from bottom to top), and its geometric factor is great and is green and blue regions in FIG. 10C. The result shows: the eddy current field propagates from bottom to top along such region or path, and a formation (a middle white portion in FIG. 10A and a middle red portion in FIG. 10C) in the axis is not measured.

The propagation characteristics of the eddy current are: although the eddy current propagates in an axial direction of the coil, a medium related to its response amplitude is a certain region in the radial direction. Time difference (phase difference) and amplitude change obtained by the measured waveforms are caused by conductivity of mediums of the yellow region (in the radial direction) in FIGS. 9A and 9B. FIG. 10A illustrates a section of a passing path when the eddy current propagates up and down. FIG. 10B illustrates a path section distributed contour line. FIG. 10C illustrates a stereogram, and green and blue portions in the stereogram are eddy current propagation paths.

Amplitude information and phase information caused by the propagation can be simultaneously obtained by using the transient electromagnetic field.

An exact theoretical solution is used for calculating a response when a radial four-layer (sequentially including a liquid in the well, a casing, a cement sheath and a formation from a well axis to the outside along with the radius) cased hole model is turned off to obtain FIG. 11A (a distance between the transmitter coil and the receiver coil is 0.4 m), where a long dashed line is an excitation waveform, and a short dashed line is a response waveform. A solid line and a chain line respectively are differences obtained by subtracting a response wave form (a difference of the formation eddy-current-excited responses) when the formation conductivity is 1 S/m from a response wave form when the formation conductivity is 10 S/m and 5 S/m, and its peak generates near a position, in which the change of the response waveform (the dashed line) is the fastest. Response waveform amplitudes at different source distances are represented by using gray scales to obtain FIG. 11B, and a waveform amplitude obtained by subtraction of response waveforms of different formation conductivities is represented by using the gray scale to obtain FIG. 11C. It can be seen from the drawings: if the source distances are different, the shape of the response waveform at a close source distance (which is less than 0.5 m) rapidly changes; however, after the waveforms of different formation conductivities are subtracted, the shapes of the waveforms at all source distances are the same and do not change along with the frequency, which is a propagation characteristic at the constant speed. It is a response caused by formation eddy current. After the waveforms are subtracted, direct coupling response unassociated with the conductivity and eddy current response of the liquid in the well, the casing and the cement sheath are removed, and only a response difference caused by the formation eddy current is left, which is consistent with the characteristics of one-way propagation and constant propagation speed (which is not changed along with the frequency) of the eddy-current-excited response described in equation (1).

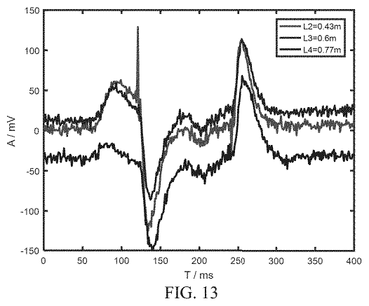

An instrument having one transmitter coil T and four receiver coils R1-R4 shown in FIG. 12A is placed in a petroleum cased hole with the diameter of 5.5 inches, and measurement is conducted in excitation manners of delaying 60 ms, forwardly turning on 60 ms, forwardly turning off 60 ms, reversely turning on 60 ms and reversely turning off 160 ms to obtain an original logging waveform shown in FIG. 12B.

The shape of a response waveform (in near field) at a first source distance L1=0.28 m is remarkably different from the shapes of waveforms at the other three source distances.

However, each waveform has a peak, the peak achievement time is prolonged along with the increasing of the source distance, and the response has remarkable propagation characteristics. It is a response (a solution of the equation (3) has attenuation and phase shift to show the propagation characteristics): the propagation speed is slow and changes along with the frequency, and the shape of the waveforms in the propagating process is changed.

Waveforms shown in FIG. 13 are obtained by subtraction of waveforms measured at the same source distance and different depths (where the formation conductivity is different). Peaks of the source distance L2 and L3 are basically superposed, the phase difference is small, and the shapes of the waveforms are consistent, that is, the shapes of the waveforms at the different source distances are the same. Different from the originally measured waveform shape in FIG. 5, at a former position of the original waveform peak, a peak is generated after the waveforms are subtracted, and such shape is consistent with the shape of a solid line in FIG. 11A. It is an eddy-current-excited response waveform, the propagation speed is a constant, and the shapes of response waveforms at different source distances are consistent.

In conclusion, the frequency spectrum of transient electromagnetic excitation is continuous, and the amplitude of a low-frequency portion is great. In the conductive medium, its response is mainly determined by conducting current, and the attenuation coefficient and the propagation speed change along with the frequency. The propagation characteristics are attenuation and phase shift, the propagation speed changes along with the frequency, and the shape of waveform changes with the increasing of the source distance. However, its eddy-current-exited response propagates at a constant speed, the shape of the waveform does not change along with the source distance, the medium in the axis does not have contribution to the response, the contribution of the conductivity of an ellipsoidal medium in a region having a certain radius to the response is great, and the conductivity propagates along the ellipsoidal medium.

The present invention also discloses the following technical effects:

the present invention can generate a low-frequency electromagnetic field with continuous spectrum by periodically turning on and turning off the transmitter coil, and the low-frequency electromagnetic field has a great skin depth, can effectively penetrate the transmitter well into the formation and overcomes the shielding function of the transmitter well; the transmitter well is internally provided with the transmitter coil and also provided with the first array receiver coil such that the transmitter well can provide a transient electromagnetic field for the receiver well and can also receive the transient electromagnetic field to conduct continuous measurement on formation conductivity outside the transmitter well so as to obtain a formation conductivity curve; and the transmitter coil and the first array receiver coil simultaneously and continuously move and measure to obtain continuous transient electromagnetic full wave forms in the transmitter well and between the transmitter well and the receiver well so as to more comprehensively and accurately reflect the formation conductivity distribution, and the array receiver coil adopts a non-contact measurement method, which is easier to be operated, highly efficient and safe to constructors.

Each embodiment of the present specification is described in a progressive manner, each embodiment focuses on the difference from other embodiments, and the same and similar parts between the embodiments may refer to each other.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

What is claimed is:

1. A method for measuring formation conductivity distribution based on transient electromagnetic eddy current field, comprising:
arranging a transmitter coil and a first array receiver coil to a target stratum of a transmitter well;
arranging a second array receiver coil to a target stratum of a receiver well;
periodically turning on and turning off the transmitter coil;
moving the transmitter coil and the first array receiver coil for a first preset distance;
acquiring a first eddy current signal of the first array receiver coil and a second eddy current signal of the second array receiver coil in a moving process of the first preset distance;
moving the second array receiver coil for a second preset distance;
jumping to the step of moving the transmitter coil and the first array receiver coil for the first preset distance till the measurement of the whole well segments is completed; and
obtaining formation conductivity distribution according to the first eddy current signal and the second eddy current signal.

2. The method for measuring formation conductivity distribution based on transient electromagnetic eddy current field according to claim 1, wherein the transmitter coil and the first array receiver coil are connected by a connecting rod.

3. The method for measuring formation conductivity distribution based on transient electromagnetic eddy current field according to claim 1, wherein there are one or more receiver wells.

4. The method for measuring formation conductivity distribution based on transient electromagnetic eddy current field according to claim 1, wherein the periodically turning on and turning off the transmitter coil comprises forward turning on, forward turning off, reverse turning on and reverse turning off.

5. The method for measuring formation conductivity distribution based on transient electromagnetic eddy current field according to claim 1, wherein the periodically turning on and turning off the transmitter coil comprises delaying 60 ms, forwardly turning on 60 ms, forwardly turning off 60 ms, reversely turning on 60 ms and reversely turning off 160 ms.

6. The method for measuring formation conductivity distribution based on transient electromagnetic eddy current field according to claim 1, wherein the first preset distance is greater than the second preset distance.

7. The method for measuring formation conductivity distribution based on transient electromagnetic eddy current field according to claim 1, wherein the obtaining formation conductivity distribution according to the first eddy current signal and the second eddy current signal comprises:
obtaining a formulation conductivity curve by using deconvolution according to the first eddy current signal;
obtaining spatial formation conductivity distribution by using a whole-space geometric factor according to the second eddy current signal; and
conducting constraint solving on the spatial formation conductivity distribution by taking the formation conductivity curve as a known boundary condition to obtain the formation conductivity distribution.
